(19) United States
(12) Patent Application Publication
(10) Pub. No.: US 2019/0349879 A1
(43) Pub. Date: Nov. 14, 2019

(54) COMMUNICATION SYSTEM AND COMMUNICATION APPARATUS

(71) Applicants: SHARP KABUSHIKI KAISHA, Sakai City, Osaka (JP); FG Innovation Company Limited, Tuen Mun, New Territories (HK)

(72) Inventors: SEIJI SATO, Sakai City, Osaka (JP); YASUHIRO HAMAGUCHI, Sakai City, Osaka (JP); HIDEO NAMBA, Sakai City, Osaka (JP); MASAFUMI ARAMOTO, Sakai City, Osaka (JP); SHUICHIRO CHIBA, Sakai City, Osaka (JP); YOKO KUGE, Sakai City, Osaka (JP); YUDAI KAWASAKI, Sakai City, Osaka (JP)

(21) Appl. No.: 16/469,966

(22) PCT Filed: Dec. 19, 2017
(86) PCT No.: PCT/JP2017/045498

§ 371 Date: Jun. 14, 2019

(30) Foreign Application Priority Data
Dec. 19, 2016 (JP) 2016-245164

(51) Int. Cl. H04W 60/00; H04W 4/70; H04L 29/08; H04W 36/00

(52) U.S. Cl. CPC H04W 60/005; H04W 36/0069; H04L 67/16; H04W 4/70

(57) ABSTRACT

In the present invention, in a case that an AE requests to change a registrar CSE from a first CSE to a second CSE, an AE-ID, a resource ID of an AE management resource, and a CSE-ID of the registrar CSE, or one of these, is included in a re-registration request. This enables reuse of the AE management resource, thus allowing the amount of communication between the AE and the registrar CSE to be reduced.

### TECHNICAL FIELD

The present invention relates to a communication system and a communication apparatus.

This application claims priority based on JP 2016-245164 filed on Dec. 19, 2016, the contents of which are incorporated herein by reference.

### BACKGROUND ART

In recent years, research and development on Internet of Things (IoT) have been rapidly promoted. The IOT allows various objects to be interconnected by network and to exchange information to realize various services, and standardization and practical use of such communication have been partly accomplished. One of the communication standards of IoT is oneM2M specified in NPL 1.

FIGS. 10A to 10C are diagrams describing the configuration of a node according to oneM2M. As illustrated from FIGS. 10A to 10C, one node includes a communication service entity (abbreviated as CSE below) or an application entity (abbreviated as AE below) or both. In oneM2M, the functions and communication method are shared, and offered by CSEs. AEs connect mainly with CSEs, use functions by the shared communication method, and provide with application services.

FIGS. 11A to 11C illustrates the connection configurations of nodes. As illustrated in FIG. 11A, a node that only includes an AE within the node can connect with a CSE of another node. As illustrated in FIG. 11B, in a case of including an AE and a CSE within a node, the AE and the CSE in the node are connected, and the CSE can further connect with a CSE of another node. As illustrated in FIG. 11C, in a case of only including a CSE within a node, the CSE can connect with a node including another CSE, and the CSE can connect with a node including still another CSE in multi-stages.

FIG. 12 illustrates an example of a system configuration according to oneM2M. 1201 is an infrastructure node (abbreviated as IN below), and is a node to manage the whole system. The IN also includes a CSE, and the CSE is referred to as an IN-CSE here. 1202 and 1203 do not have a CSE, and are application dedicated nodes (abbreviated as ADNs below) including only an AE. 1204, 1205, and 1209 are nodes to include both an AE and a CSE, and are referred to as application service nodes (abbreviated as ASNs below). An ADN and an ASN are placed in a device apparatus connected to a terminal of a communication system such as a camera or a sensor, and the like. 1206, 1207, and 1208 are located at the middle of an ASN and ADN and an IN, and are nodes to have a function of a gateway, and are referred to as middle nodes (abbreviated as MNs below). Note that, although, in FIG. 12, an IN and an MN are in a configuration not including an AE, each may include an AE within the node. As illustrated in FIG. 12, MNs and ADNs and ASNs are connected in a tree structure with the IN at the top, constituting one communication system. This communication system configuration is referred to as a domain.

An AE in an ASN or an ADN requests connection with a CSE in the same node or a CSE in another node, and can use the communication function by the request being accepted. This is referred to as registration. By a CSE also similarly performing registration with another CSE, it can use the communication function. A CSE with which registration is requested by an AE or a CSE and is accepted is referred to as a registrar CSE.

In a case that an AE performs registration with a registrar CSE, an ID for identification is allocated. This is referred to as an AE-ID. FIGS. 13A and 13B illustrate an example of the configuration of an AE-ID. In the example illustrated in FIGS. 13A and 13B, AE-IDs has two types. FIG. 13A is an AE-ID allocated in a registrar CSE, and has unique value in the registrar CSE. In other words, the part (“Cabcde”) described with AE-ID in FIG. 13A is distinguishable uniquely in the registrar CSE, but another CSE may allocate it to another AE outside the registrar CSE and may not be identified uniquely. Therefore, as illustrated in FIG. 13A, by adding a CSE-ID before an AE-ID to identify a registrar CSE in a domain uniquely to make an intra-domain distinguishable AE-ID, or further adding a domain ID to identify a domain represented with FQDN uniquely to make an unlimited distinguishable AE-ID, the identifiable range can be extended.

On the other hand, FIG. 13B illustrates an AE-ID in a case that the allocation is performed in an IN, and has a unique value in a domain. In other words, the part (“Sqwert”) described with AE-ID in FIG. 13B is the domain management AE-ID which can be identified in the domain uniquely with that alone. By adding a domain ID before AE-ID, it can be an unlimited distinguishable AE-ID which can extend the identification range outside the domain.

An example of the method to determine whether an AE-ID is the type of the AE-ID illustrated in FIG. 13A or the type of the AE-ID illustrated in FIG. 13B is a method to limit an initial character of the AE-ID depending on respective types. In the example of FIGS. 13A and 13B, by making without fail the first character of the all AE-IDs either one of two, the type of FIG. 13A being the capital C of the alphabet and the type of FIG. 13B being the capital S of the alphabet, which type an AE-ID is can be determined. For convenience, an AE-ID of the type of FIG. 13A is referred to as an AE-ID (C), and an AE-ID of the type of FIG. 13B is referred to as an AE-ID (S) below.

In a case that an AE is performed registration with a registrar CSE, in the registrar CSE, an AE management resource to manage the information about the AE is created. FIG. 14 illustrates an example of the configuration of the AE management resource. As illustrated in FIG. 14, information about an AE including an AE-ID, a registration date, and authentication information is stored in an AE management resource. As for information such as devices connected to the AE, management resources are also created by a registration request from the AE to the registrar CSE in the registrar CSE, and plurally associated and managed as child resources of the AE management resource. Therefore, in the AE management resource, all management information of the AE registered with the registrar CSE is stored.

FIG. 15 illustrates a flow in a case that an AE performs registration with a CSE. Note that, in FIG. 15, an IN-CSE refers to a CSE included in an IN. At first, an AE sends a request of registration to a registrar CSE (step S1501). The registrar CSE having received the request of registration from the AE performs an authentication process with an IN-CSE whether the AE can be registered with a domain (step S1502). Then, the registrar CSE confirms parameters of the request received from the AE in step S1501, and determines whether the AE requires an AE-ID (S) (step S1503). In a case of determining that the AE does not require an AE-ID (S) in step S1503, the registrar CSE creates a new AE-ID (C) (step S1504). In a case of determining that the AE requires an AE-ID (S) in step S1503, the registrar CSE sends a request of AE-ID (S) creation to the IN-CSE (step S1505). The IN-CSE having received the AE-ID (S) creation request from the registrar CSE creates an AE-ID (S) (step S1506). Then, the IN-CSE creates a resource for the domain management (step S1507) and sends a success response to the request of the AE public registration received in step S1505 to the registrar CSE (step S1508). At this time, the IN-CSE includes the AE-ID (S) created in step S1506 in the parameter of the response. After completing either creating an AE-ID (C) in step S1504 or receiving the AE-ID (S) creation success response from the IN-CSE in step S1508, the registrar CSE creates an AE management resource (step S1509) and sends a success response to the request of registration received in step S1501 to the AE (step S1510), and the proceeding of the registration is completed (step S1511). Then, the AE sends a request for each device to the registrar CSE to register devices connected to the node including the AE with the CSE, and the like, and the registrar CSE performs allocation of resource IDs or creation of management resources for the devices, and the like (S1512).

### CITATION LIST

### Non Patent Literature

NPL 1: oneM2M Technical Specification TS-0001-V2.10.0 Functional Architecture 2016 Aug. 30

### SUMMARY OF INVENTION

### Technical Problem

However, by the above-mentioned conventional communication method, in a case that the AE changes the registrar CSE by performing registration to another CSE, there is a problem that the AE needs to perform re-registration of the resource each time and communication between the AE and the registrar CSE increases.

One aspect of the present invention is made in view of the above described problem, and the purpose is to provide a communication procedure that can reduce communication traffic volume between the AE and registrar the CSE in a case that the AE changes the registrar CSE by performing registration.

### Solution to Problem

(1) One aspect of the present invention is to solve the above-mentioned problem, and a communication system according to one aspect of the present invention is a communication system including at least an infrastructure node (IN) and a communication service entity (CSE) connected to a network, the communication system providing an application entity (AE) with an end-to-end communication service between machines by the CSE and the IN communicating with each other, wherein a first CSE having received a registration request from the AE creates an AE identifier to identify the AE, an AE management resource to manage states of the AE, and a resource identifier of the AE management resource, and transmits the AE identifier and the resource identifier to the AE, in a case that the AE changes registration from the first CSE to a second CSE, the second CSE having received a registration request including the resource identifier from the AE transmits, to the IN, an address resolution request to request an address of the first CSE that is holding the AE management resource specified by the resource identifier, the IN describes the address of the first CSE in a response to the address resolution request from the second CSE, and transmits the response to the second CSE, the second CSE transmits, to the first CSE, an AE management resource acquisition request of the AE management resource specified by the resource identifier, by using the address of the first CSE included in the response to the address resolution request from the IN, the first CSE transmits contents of the AE management resource to the second CSE, according to the AE management resource acquisition request specified by the resource identifier, and the second CSE performs registration processing of the AE, by using the contents of the AE management resource received from the first CSE.

(2) A communication service entity (CSE) according to one aspect of the present invention is a CSE for communicating with an infrastructure node (IN) and an application entity (AE) connected to a network, wherein in a case that an AE management resource identified by a resource identifier included in a registration request from the AE is valid, the CSE transmits an AE management resource acquisition request of the AE management resource to a management CSE of the AE management resource, and the CSE performs registration processing of the AE, by using contents of the AE management resource included in a response to the AE management resource acquisition request received from the management CSE of the AE management resource.

(3) An application entity (AE) according to one aspect of the present invention is an AE for communicating with an infrastructure node (IN) and a communication service entity (CSE) connected to a network, wherein in a case of changing a registration CSE from a first CSE to a second CSE, the AE transmits, to the second CSE, a registration request including a resource identifier of an AE management resource of the AE notified by the first CSE.

(4) A communication system according to one aspect of the present invention is a communication system including at least an infrastructure node (IN) and a communication service entity (CSE) connected to a network, the communication system providing an application entity (AE) with an end-to-end communication service between machines by the CSE and the IN communicating with each other, wherein a first CSE having received a registration request from the AE creates an AE identifier to identify an AE, an AE management resource to manage a state of the AE, and a resource identifier of the AE management resource, and transmits the AE identifier and the resource identifier to the AE, in a case that the AE changes registration from the first CSE to a second CSE, the second CSE having received the resource identifier and a CSE identifier to identify the first CSE from the AE transmits, to the first CSE specified by the CSE identifier, an AE management resource acquisition request of the AE management resource specified by the resource identifier, the first CSE transmits contents of the AE management resource to the second CSE, according to the AE management resource acquisition request specified by the resource identifier, and the second CSE performs registration processing of the AE, by using the contents of the AE management resource transmitted from the first CSE.

(5) A communication service entity (CSE) according to one aspect of the present invention is a CSE for communicating with an infrastructure node (IN) and an application entity (AE) connected to a network, wherein in a case that a CSE identifier included in a registration request from the AE is valid, the CSE transmits an AE management resource acquisition request of an AE management resource to a CSE, specified by the CSE identifier, that is configured to manage the AE management resource specified by a resource identifier, and the CSE performs registration processing of the AE, by using contents of the AE management resource included in a response to the AE management resource acquisition request from the CSE specified by the CSE identifier.

(6) An application entity (AE) according to one aspect of the present invention is an AE for communicating with an infrastructure node (IN) and a communication service entity (CSE) connected to a network, wherein in a case of changing a registration CSE from a first CSE to a second CSE, the AE transmits, to the second CSE, a registration request including a resource identifier of an AE management resource of the AE notified by the first CSE and a CSE identifier of the first CSE.

(7) A communication system according to one aspect of the present invention is a communication system including at least an infrastructure node (IN) and a communication service entity (CSE) connected to a network, the communication system constructing a domain to provide an application entity (AE) with an end-to-end communication service between machines by the CSE and the IN communicating with each other, wherein a first CSE having received a registration request transmitted by the AE creates an intra-CSE distinguishable AE identifier to identify an AE uniquely in the first CSE, an AE management resource to manage a state of the AE, and a resource identifier of the AE management resource, and transmits the intra-CSE distinguishable AE identifier and the resource identifier to the AE, in a case that the AE changes registration from the first CSE to a second CSE, the second CSE having received, from the AE, a registration request including the intra-CSE distinguishable AE identifier transmitted from the first CSE and a CSE identifier to identify the first CSE uniquely in the domain transmits, to the first CSE, an AE management resource acquisition request of the AE identified by the intra-CSE distinguishable AE identifier, by using the CSE identifier, the first CSE transmits, to the first CSE, contents of the AE management resource acquisition request of the AE identified by the intra-CSE distinguishable AE identifier specified by the AE management resource acquisition request, and

the second CSE performs registration processing of the AE, by using the contents of the AE management resource received from the first CSE.

(8) A communication system according to one aspect of the present invention is the above described communication system, wherein the CSE identifier of the first CSE included in the registration request received by the second CSE from the AE is included as a parameter different from the intra-CSE distinguishable AE identifier.

(9) A communication system according to one aspect of the present invention is the above described communication system, wherein the CSE identifier of the first CSE included in the registration request received by the second CSE from the AE is added to the intra-CSE distinguishable AE identifier.

(10) A communication service entity (CSE) according to one aspect of the present invention is a CSE for communicating with an infrastructure node (IN) and an application entity (AE) connected to a network, wherein the CSE receives a registration request including a CSE identifier and an intra-CSE distinguishable AE identifier from the AE, in a case that the CSE identifier is different from the CSE identifier of the CSE, the CSE transmits an AE management resource acquisition request of the AE management resource to a management CSE configured to manage an AE management resource of the AE identified by the CSE identifier and the intra-CSE distinguishable AE identifier, and the CSE performs registration processing of the AE, by using contents of the AE management resource included in a response to the AE management resource acquisition request from the management CSE.

(11) A communication service entity (CSE) according to one aspect of the present invention is the above described CSE, wherein the CSE identifier included in the registration request received from the AE is included as a parameter different from the intra-CSE distinguishable AE identifier.

(12) A communication service entity (CSE) according to one aspect of the present invention is the above described CSE, wherein the CSE identifier of a first CSE included in the registration request received from the AE is added to the intra-CSE distinguishable AE identifier.

(13) An application entity (AE) according to one aspect of the present invention is an AE for communicating with an infrastructure node (IN) and a communication service entity (CSE) connected to a network, wherein in a case of changing a registration CSE of the AE from a first CSE to a second CSE, the AE transmits, to the second CSE, a registration request including an intra-CSE distinguishable AE identifier of the AE notified by the first CSE and a CSE identifier of the first CSE.

(14) An application entity (AE) according to one aspect of the present invention is the above described AE, wherein the CSE identifier included in the registration request transmitted to the second CSE is included as a parameter different from the intra-CSE distinguishable AE identifier.

(15) An application entity (AE) according to one aspect of the present invention is the above described AE, wherein the CSE identifier included in the registration request transmitted to the second CSE is added to the intra-CSE distinguishable AE identifier.

(16) A communication system according to one aspect of the present invention is a communication system including at least an infrastructure node (IN) and a communication service entity (CSE) connected to a network, the communication system constructing a domain to provide an application entity (AE) with an end-to-end communication service between machines by the CSE and the IN communicating with each other, wherein a first CSE having received a registration request from the AE transmits, to the IN, a domain management AE identifier creation request for requesting creation of a domain management AE identifier to identify the AE uniquely in the domain, the IN creates the domain management AE identifier, and transmits, to the first CSE, a domain management AE identifier creation request response including the domain management AE identifier, the first CSE creates an AE management resource to manage a state of the AE and a resource identifier of the AE management resource, and transmits, to the AE, the domain management AE identifier and the resource identifier included in the domain management AE identifier creation request response, in a case that the AE changes registration from the first CSE to a second CSE, the second CSE having received a registration request including the domain management AE identifier from the AE transmits, to the IN, an AE management resource holding CSE resolution request to request resolution of a CSE that holds the AE management resource of the AE identified by the domain management AE identifier included in the registration request, the IN describes a CSE identifier and an address of the first CSE in a response to the AE management resource holding CSE resolution request from the second CSE, and transmits the response to the second CSE, the second CSE transmits, to the first CSE, an AE management resource acquisition request of the AE specified by the domain management AE identifier, by using the CSE identifier and the address of the first CSE included in the response to the AE management resource holding CSE resolution request from the IN, the first CSE transmits, to the second CSE, contents of the AE management resource acquisition request of the AE identified by the domain management AE identifier specified by the AE management resource acquisition request, and the second CSE performs registration processing of the AE, by using contents of the AE management resource received from the first CSE.

(17) A communication service entity (CSE) according to one aspect of the present invention is a CSE for communicating with an infrastructure node (IN) and an application entity (AE) connected to a network, wherein the CSE receives a registration request including a domain management AE identifier from the AE, in a case that the domain management AE identifier is different from a CSE identifier of the CSE, the CSE transmits, to the IN, an AE management resource acquisition request of the AE management resource to a management CSE configured to manage an AE management resource of the AE identified by the domain management AE identifier, and the CSE performs registration processing of the AE, by using contents of the AE management resource included in a response to the AE management resource acquisition request received from the management CSE.

(18) An application entity (AE) according to one aspect of the present invention is an AE for communicating with an infrastructure node (IN) and a communication service entity (CSE) connected to a network, wherein in a case of changing a registration CSE of the AE from a first CSE to a second CSE, the AE transmits, to the second CSE, a registration request including a domain management AE identifier of the AE notified by the first CSE.

(19) A communication system according to one aspect of the present invention is a communication system including at least an infrastructure node (IN) and a communication service entity (CSE) connected to a network, the communication system constructing a domain to provide an application entity (AE) with an end-to-end communication service between machines by the CSE and the IN communicating with each other, wherein the first CSE having received a registration request from the AE transmits, to the IN, a domain management AE identifier creation request for requesting creation of a domain management AE identifier to identify the AE uniquely in the domain, the IN creates the domain management AE identifier, and transmits, to the first CSE, a domain management AE identifier creation request response including the domain management AE identifier, the first CSE creates an AE management resource to manage a state of the AE and a resource identifier of the AE management resource, and transmits, to the AE, the domain management AE identifier and the resource identifier included in the domain management AE identifier creation request response, in a case that the AE changes registration from the first CSE to a second CSE, the second CSE having received a registration request including the domain management AE identifier from the AE transmits, to the IN, a registration change request including the domain management AE identifier included in the registration request, the IN transmits, to the first CSE, an AE management resource retrieval request of the AE management resource, to the first CSE that registers the AE identified by the domain management AE identifier included in the registration change request, the first CSE transmits, to the IN, contents of the AE management resource as a response to the AE management resource retrieval request, the IN transmits, to the second CSE, the contents of the AE management resource included in the response to the AE management resource retrieval request received from the first CSE, and the second CSE performs registration processing of the AE, by using the contents of the AE management resource received from the IN.

(20) An infrastructure node (IN) according to one aspect of the present invention is an IN for communicating with an application entity (AE) and a communication service entity (CSE) connected to a network, wherein in a case of receiving a registration update request including a domain management AE identifier from the CSE, the IN transmits an AE management resource acquisition request of the AE, to a management CSE configured to manage the AE identified by the domain management AE identifier, and the IN includes, in a response to the registration update request, contents of the AE management resource included in a response to the AE management resource acquisition request received from the management CSE, and transmits the response to the CSE.

(21) A communication service entity (CSE) according to one aspect of the present invention is a CSE for communicating with an infrastructure node (IN) and an application entity (AE) connected to a network, wherein the CSE receives a registration request including a domain management AE identifier from the AE, in a case that the domain management AE identifier is registered by a CSE other than the CSE, the CSE transmits, to the IN, a registration update request including the domain management AE identifier, and the CSE performs registration processing of the AE, by using contents of an AE management resource of the AE included in a response to the registration update request received from the IN.

### Advantageous Effects of Invention

According to one embodiment of the present invention, in a case that the AE changes the registrar CSE with which the AE performs registration, communication traffic volume between the AE and the registrar CSE can be reduced.

### BRIEF DESCRIPTION OF DRAWINGS

FIG. 1 is a diagram illustrating an example configuration of a communication system according to one aspect of the present invention.

FIG. 2 is a diagram illustrating an example configuration of a CSE (IN-CSE) of an IN according to one aspect of the present invention.

FIG. 3 is a diagram illustrating an example configuration of a registrar CSE according to one aspect of the present invention.

FIG. 4 is a diagram illustrating an example configuration of an AE according to one aspect of the present invention.

FIG. 5A is a diagram illustrating an example flow of a process in which the AE performs registration with the registrar CSEa according to the first to fourth embodiments of the present invention.

FIG. 5B is a diagram illustrating an example flow of a process in which the AE performs re-registration with the registrar CSEb from the registrar CSEa according to the first embodiment of the present invention.

FIG. 6 is a diagram illustrating an example flow of a process in which the AE performs re-registration with the registrar CSEb from the registrar CSEa according to the second embodiment of the present invention.

FIG. 7 is a diagram illustrating an example flow of a process in which the AE performs re-registration with the registrar CSEb from the registrar CSEa according to the third embodiment of the present invention.

FIG. 8A is a diagram illustrating an example flow of a process in which the AE performs registration with the registrar CSEa according to the fourth and fifth embodiments of the present invention.

FIG. 8B is a diagram illustrating an example flow of a process in which the AE performs re-registration with the registrar CSEb from the registrar CSEa according to the fourth embodiment of the present invention.

FIG. 9 is a diagram illustrating an example flow of a process in which the AE performs re-registration with the registrar CSEb from the registrar CSEa according to the fifth embodiment of the present invention.

FIGS. 10A to 10C are diagrams illustrating an example configuration of a node according to related art.

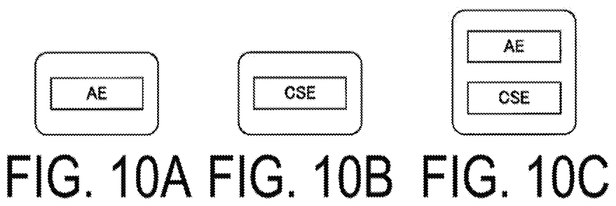

FIGS. 11A to 11C are diagrams illustrating an example configurations of connection between nodes according to related art.

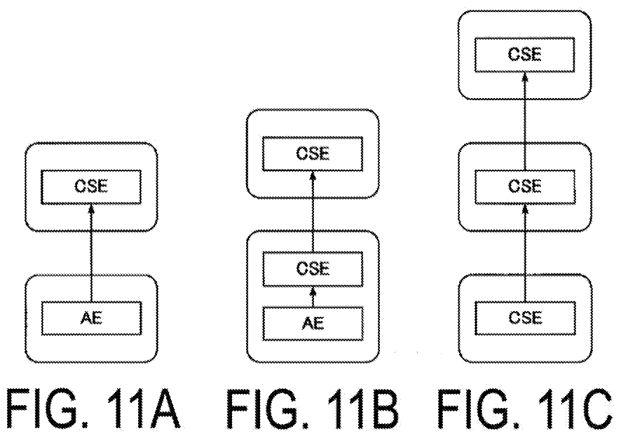

FIG. 12 is a diagram illustrating an example configuration of a domain according to related art.

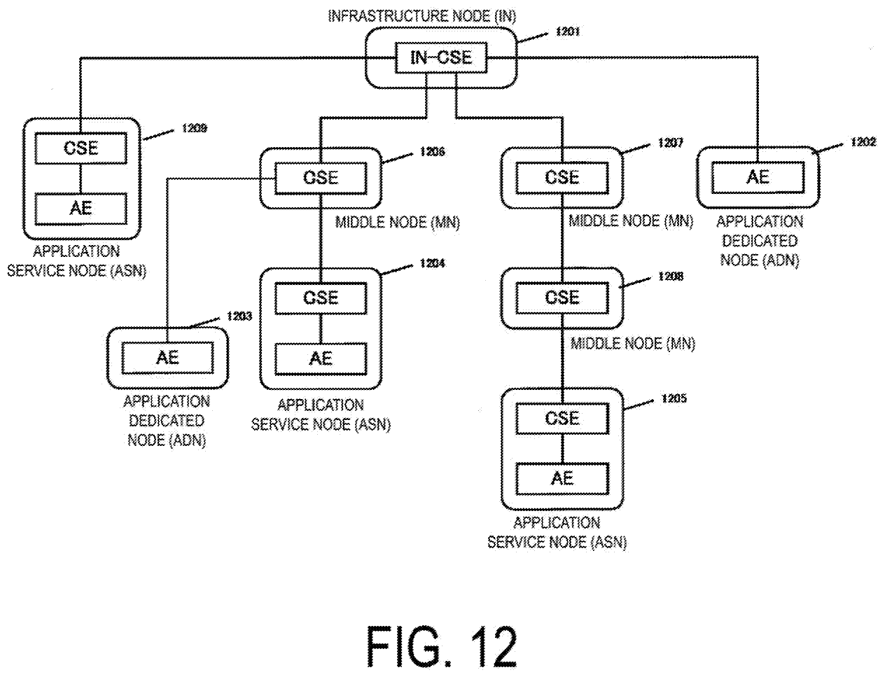

FIGS. 13A and 13B are diagrams illustrating an example configuration of an AE-ID according to related art.

FIG. 14 is a diagram illustrating an example configuration of an AE management resource according to related art.

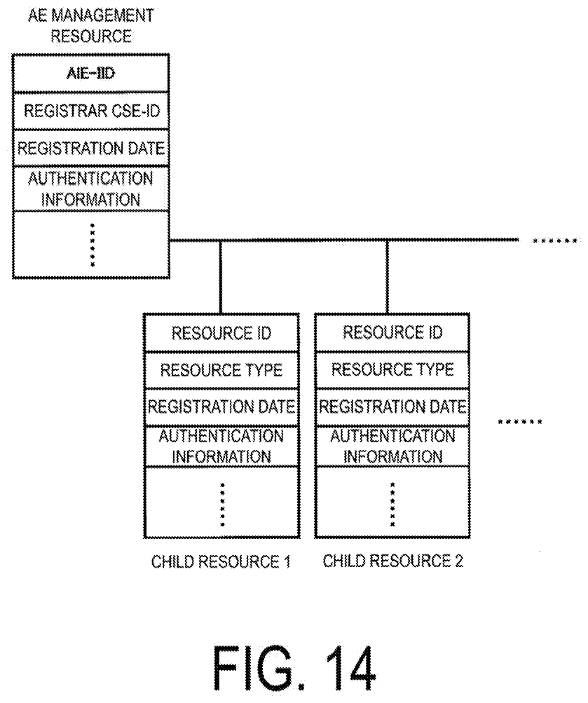

FIG. 15 is a diagram illustrating an example flow of a process in which the AE performs registration with the registrar CSE according to related art.

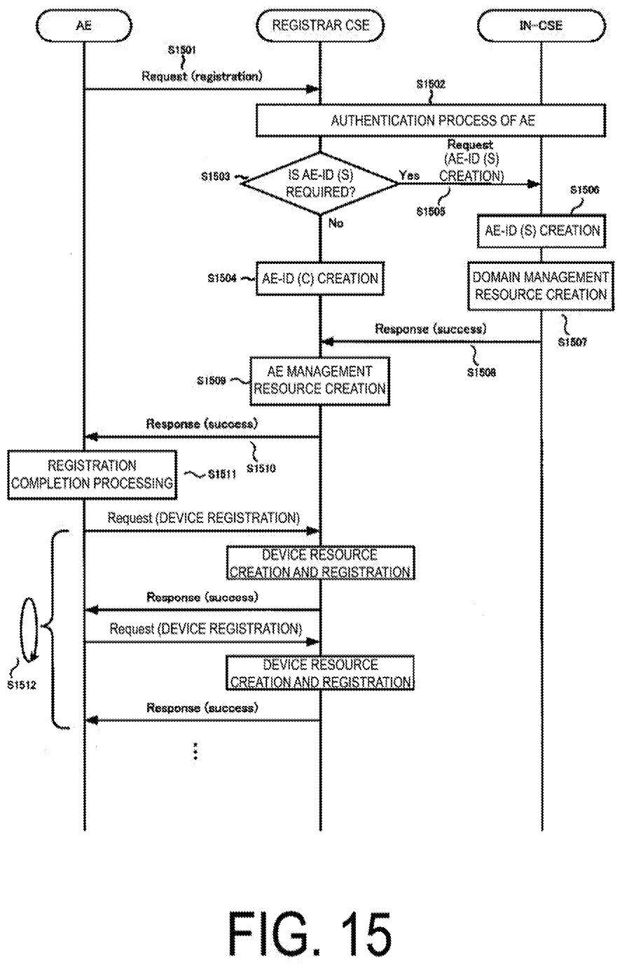

### DESCRIPTION OF EMBODIMENTS

First Embodiment: The first embodiment according to the present invention will be described with reference to the drawings below.

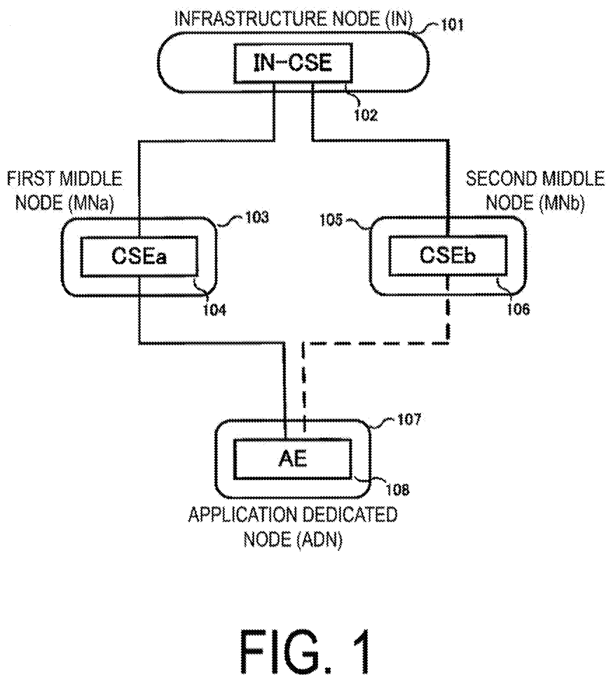

FIG. 1 is a schematic configuration diagram illustrating the configuration of a communication system according to the first embodiment of the present invention. In FIG. 1, 101 is an infrastructure node (IN) and includes an IN-CSE 102. 103 and 105 are a first middle node (MNa) and a second middle node (MNb), respectively, and includes a CSEa 104 and a CSEb 106, respectively. 107 is an application dedicated node (ADN), and includes an AE 108.

In FIG. 1, the CSEa 104 and the CSEb 106 are in a state of being in registration with the IN-CSE 102, and allocated with “CSEa” and “CSEb” as a CSE-ID which is an identifier of the CSE, respectively. The AE 108 performs communication in registration with the CSEa 104 or the CSEb 106.

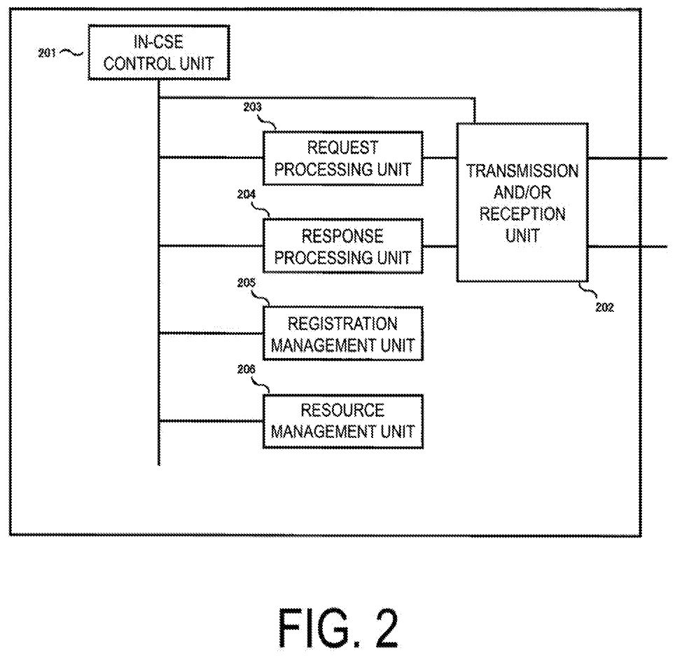

FIG. 2 illustrates an example of the configuration of the IN-CSE 102 according to the present embodiment. In FIG. 2, 201 is an IN-CSE control unit, and performs control of the whole IN-CSE. 202 is a transmission and/or reception unit, and performs transmission and/or reception of data with another CSE or AE. 203 is a request processing unit, and performs the whole processing related to requests including an analysis of a request received from another CSE or AE and a creation of a request to transmit to another CSE or AE. 204 is a response processing unit, and performs the whole processing related to responses including a creation of a response to transmit to another CSE or AE and an analysis of a response received from another CSE or AE. 205 is a registration management unit, and performs processing related to registration from another CSE or AE. 206 is a resource management unit, and performs processing related to management of a resource created by a request from another CSE or AE.

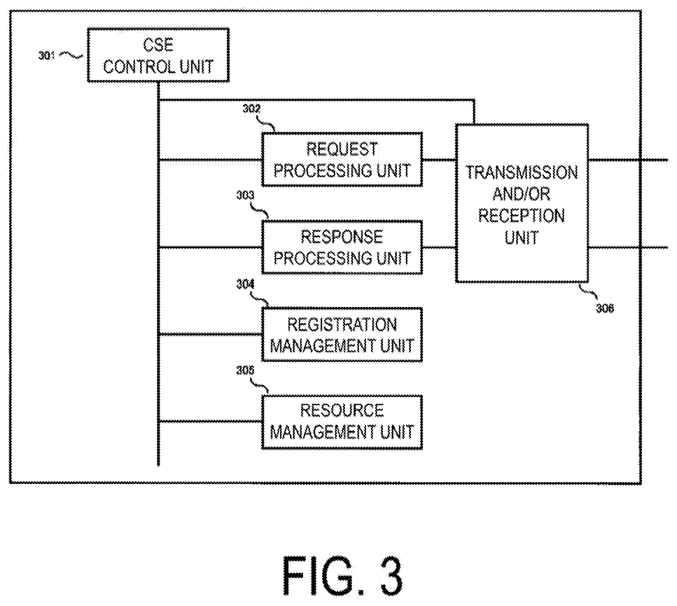

FIG. 3 illustrates an example of the configuration of the CSEa 104 and the CSEa 106 according to the present embodiment. In FIG. 3, 301 is a CSE control unit, and performs control of the whole CSE. 302 is a request processing unit, and performs the whole processing related to requests including an analysis of a request received from another CSE or AE and a creation of a request to transmit to another CSE or AE. 303 is a response processing unit, and performs the whole processing related to responses including a creation of a response to transmit to another CSE or AE and an analysis of a response received from another CSE or AE. 304 is a registration management unit, and performs processing related to registration with another CSE or AE. 305 is a resource management unit, and performs processing related to management of a resource created by a request from another CSE or AE. 306 is a transmission and/or reception unit, and performs transmission and/or reception of data with another CSE or AE. Note that the same numerals in FIG. 3 are used in description of respective operation in the following description since the CSEa 104 and the CSEb 106 are with the same configuration.

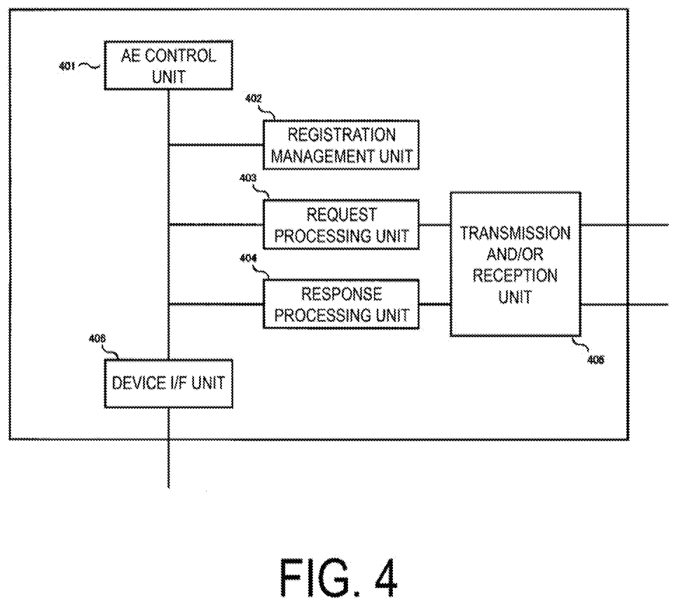

FIG. 4 illustrates an example of the configuration of the AE 108 according to the present embodiment. In FIG. 4, 401 is an AE control unit, and performs control of the whole AE. 402 is a registration management unit, and performs processing related to registration including management of an AE-ID or a CSE-ID notified by a registrar CSE. 403 is a request processing unit, and performs the whole processing related to requests including an analysis of a request received from another CSE or AE and a creation of a request to transmit to another CSE or AE. 404 is a response processing unit, and performs the whole processing related to responses including a creation of a response to transmit to another CSE or AE and an analysis of a response received from another CSE or AE. 405 is a transmission and/or reception unit, and performs transmission and/or reception of data with another CSE. 406 is a device interface (I/F) unit, and performs control related to external devices connected to the AE and transmission and/or reception of data.

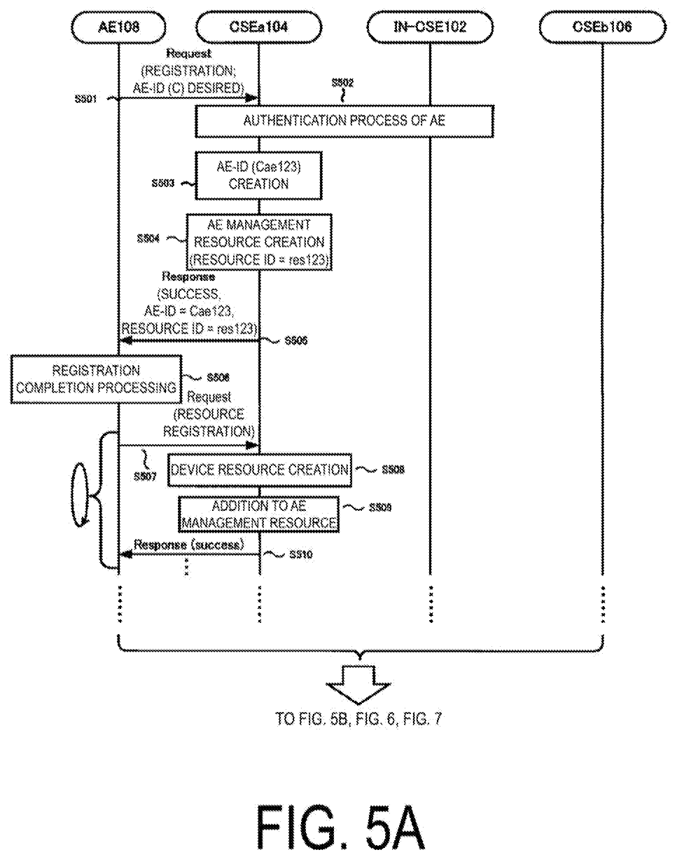

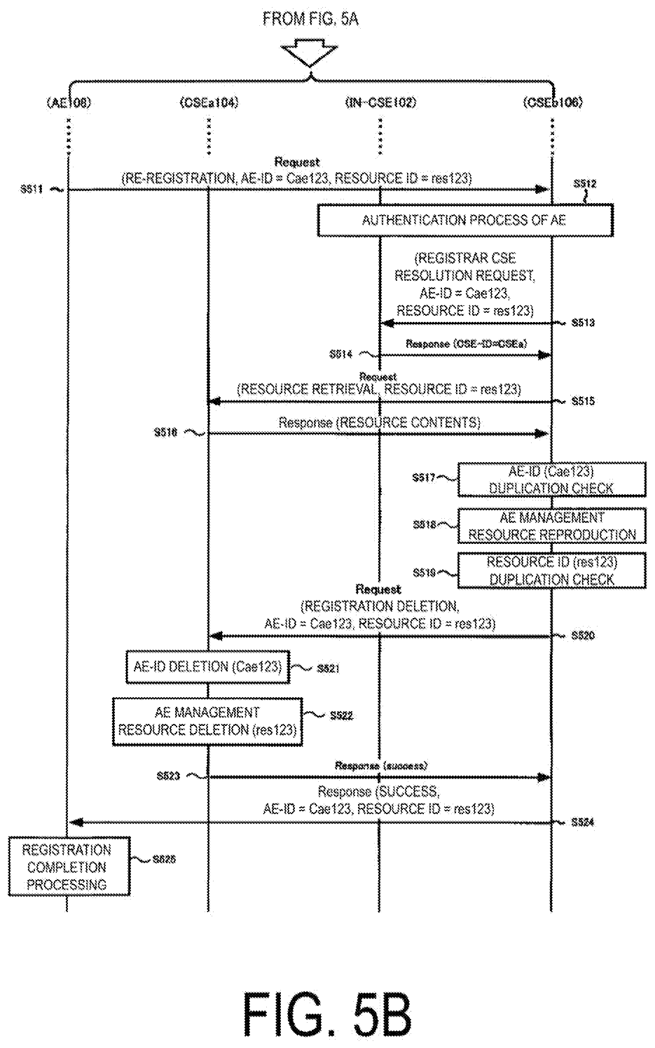

FIGS. 5A and 5B illustrated a flow of the processing of the present embodiment. FIG. 5A illustrates a flow where the AE 108 performs registration with the CSEa 104 as a registrar CSE. At first, the AE 108 creates a registration request using the request processing unit 403. At this time, the AE-ID is data desiring allocation of the intra-CSE distinguishable AE-ID (C). Then, the AE 108 transmits the registration request to the CSEa 104, using the transmission and/or reception unit 405 (step S501). The CSEa 104 having received the registration request using the transmission and/or reception unit 306 from the AE 108 performs an authentication process of the AE 108 with the IN-CSE 102 (step S502). In a case that the authentication process of the AE 108 is completed, the CSEa 104 preforms analysis of the registration request using the request processing unit 302, and determines that it is a new registration and that the AE-ID which the AE desires is the intra-CSE distinguishable AE-ID (C), and the registration management unit 304 performs a new AE-ID creation (step S503). Here, for one example, the new AE-ID is assumed and created as “Cae123” being the AE-ID (C). The resource management unit 305 creates the AE management resource and assumes the resource ID as res123 (step S504). Note that the resource ID of the AE management resource may be the same value as the AE-ID. Then, in a case that the registration request received in step S501 is successful, the response processing unit 303 creates a response to respond in having allocated Cae123 as the AE-ID and res123 as the resource ID of the AE management resource, and the transmission and/or reception unit 306 transmits it to the AE 108 (step S505). In a case that the AE 108 receives a registration success response from the CSEa 104 using the transmission and/or reception unit 405, the response processing unit 404 extracts the AE-ID (Cae123) and the resource ID (res123) from the response, the registration management unit 402 stores the AE-ID (Cae123), the resource ID (res123), and the CSE-ID (CSEa) of the registrar CSE (CSEa 104), and the registration is completed (step S506). In a case that the registration is completed, the AE 108 transmits a resource registration request to register devices which the ADN 107 has with the CSEa 104 (step S507), and the CSEa 104 creates device resources depending on the resource registration request (step S508), adds the device resources to the AE management resource (step S509), and transmits a response to the AE 108 (step S510). The AE 108 and the CSEa 104 repeats step S507 to step S510 as many times as the number of devices which the ADN 107 has.

FIG. 5B illustrates a flow from the state where FIG. 5A is completed, until the AE 108 changes the registrar CSE to the CSEb 106 and the re-registration is completed. At first, the AE 108 creates a re-registration request to the CSEb 106 using the request processing unit 403. At this time, the AE 108 describes the AE-ID (Cae123) and the resource ID (res123) managed by the registration management unit 402 in this re-registration request, and transmits it to the CSEb 106 using the transmission and/or reception unit 405 (step S511). In a case that the CSEb 106 receives the re-registration request from the AE 108 using the transmission and/or reception unit 306, at first the CSEb 106 performs an authentication process of the AE 108 with the IN-CSE 102 (step S512). In a case that the authentication process of the AE 108 is completed, the CSEb 106 performs analysis of the registration request using the request processing unit 302, and extracts that it is re-registration and the AE-ID (Cae123) and the resource ID (res123) thereof. And in a case that the registration management unit 304 and the resource management unit 305 determine that the AE-ID (Cae123) and the resource ID (res123) are not managed in the CSEb 106, the request processing unit 302 creates a registrar CSE resolution request to inquire what is the AE with AE-ID=Cae123 and what is the registrar CSE managing the AE management resource (resource ID=res123) thereof, and the transmission and/or reception unit 306 transmits it to the IN-CSE 102 (step S513). In a case that the IN-CSE 102 receives the registrar CSE resolution request from the CSEa 104 using the transmission and/or reception unit 202, the request processing unit 203 analyzes the registrar CSE resolution request, the response processing unit 204 creates a response including the CSE-ID (CSEa) of the CSEa 104 which is the registrar CSE from the AE-ID (Cae123) and resource ID (res123), and the transmission and/or reception unit 202 transmits it to the CSEb 106 (step S514). The CSEb 106 grasps the AE with the AE-ID=Cae123 and that the registrar CSE managing the AE management resource (resource ID=res123) is the CSEa 104 (CSE-ID=CSEa), by the response processing unit 303 analyzing the response received with the transmission and/or reception unit 306, the request processing unit 302 creates a resource retrieval request of the resource ID=res123, and the transmission and/or reception unit 306 transmits it to the CSEa 104 (step S515). The CSEa 104 retrieves the AE management resource of the resource ID=res123 targeted for the resource retrieval request, by the request processing unit 302 analyzing the resource retrieval request received using the transmission and/or reception unit 306, the response processing unit 303 creates a response including the contents, and the transmission and/or reception unit 306 transmits it to the CSEb 106 (step S516). The CSEb 106 receives the response from the CSEa 104 using the transmission and/or reception unit 306, analyzes it using the response processing unit 303, and extracts the AE management resource of the resource ID=res123, the registration management unit 304 confirms whether the AE-ID=Cae123 is not already allocated to another AE in the CSEb 106, and assumes the AE-ID as Cae123 in a case of being not allocated, or creates a new AE-ID in a case that it has been already allocated (step S517). Note that, at this time, a new AE-ID may be allocated regardless of whether allocation has been already done. Here, the AE-ID=Cae123 is reused unchanged. With respect to contents of the AE management resource extracted from the response, the resource management unit 305 creates an AE management resource, by rewriting to the CSE-ID (CSEb) of the CSEb 106 in a case that there is something related to the CSE-ID (CSEa) of the CSEa 104, and reproducing other things unchanged (step S518). The resource management unit 305 confirms whether the resource ID=res123 of the AE management resource is not already allocated to another resource in the CSEb 106, and assumes the resource ID as res123 in a case of being not allocated, or creates a new resource ID in a case that it has been already allocated (step S519). Note that, at this time, a new resource ID may be allocated regardless of whether allocation has been already done. Here, the resource ID=res123 is reused unchanged. Then, the request processing unit 302 creates a request to request deletion of the registration of the AE-ID=Cae123 and the resource ID=res123, and the transmission and/or reception unit 306 transmits it to the CSEa 104 (step S520). The CSEa 104 confirms that the registration deletion target are the AE of the AE-ID=Cae123 and the AE management resource of the resource ID=res123, by the request processing unit 302 analyzing the registration deletion request from the CSEa 104 received using the transmission and/or reception unit 306, the registration management unit 304 deletes the registration information of the AE-ID=Cae123 (step S521), and the resource management unit 305 deletes the AE management resource of the resource ID=res123 (step S522). The response processing unit 303 creates a success response to the registration deletion request received from the CSEb 106 in step S520, and the transmission and/or reception unit 306 transmits it to the CSEb 106 (step S523). The CSEb 106 receives and confirms the deletion success response to the registration deletion request transmitted in step S520 using the transmission and/or reception unit 306 and the response processing unit 303, the response processing unit 303 creates a success response to the re-registration request from the AE 108 received in step S511 including the AE-ID=Cae123 and the resource ID=res123, and the transmission and/or reception unit 306 transmits it to the AE 108 (step S524). In a case that the AE 108 receives and confirms the success response to the re-registration request transmitted in step S511 from the CSEb 106 using the transmission and/or reception unit 405 and the response processing unit 404, the registration management unit 402 lets the AE-ID as Cae123 (no change) and resource ID of the AE management resource as res123 (no change), and rewrites the CSE-ID of the registrar CSE to the CSE-ID (CSEb) of the CSEb 106. By this, the procedure of the re-registration is completed (step S525). Note that the device resource registration procedure of FIG. 5A (repetition from step S507 to S510) is not performed. This is because conversion of the resource has been already performed from the CSEa 104 to the CSEb 106.

Note that although the present embodiment is described assuming that the values of the AE-ID of the AE and the resource ID of the AE management resource are allocated differently, the AE-ID and the resource ID may be allocated to the same value. In that case, it is not necessary to describe the AE-ID and the resource ID as separate parameters in each request and response, and only AE-ID may be described.

Although the CSEb 106 transmits the CSE resolution request to the IN-CSE 102 to perform inquiry of the CSE (CSEa 104) managing the AE-ID (Cae123) and the resource ID (res123) in step S513, the CSEb 106 may perform inquiry to an entity managing all or some of CSEs in the domain including, for example, the DNS (domain name service) server.

Although the present embodiment is described assuming all the steps after the AE 108 transmits the re-registration request to the CSEb 106 (step S511) until the CSEb 106 transmits the re-registration success response to the AE 108 (step S524) are successful, the CSEb 106 may transmit, to the AE 108, a response indicating failure to the re-registration request which the AE 108 has transmitted to the CSEb 106 in step S511 in a case that part or all of the steps fail during this period. In this case, the CSEb 106 may transmit it including parameters to indicate reasons or the degree (part or all) of the failure in this response. The AE 108 receives and analyzes this re-registration failure response, and depending on the reasons and the degree and the like, the AE 108 may perform retransmission of the re-registration request, or the CSEb 106 may perform renewal of the acquisition device resource creation of the AE management resource from the CSEa 104, and the like, selectively.

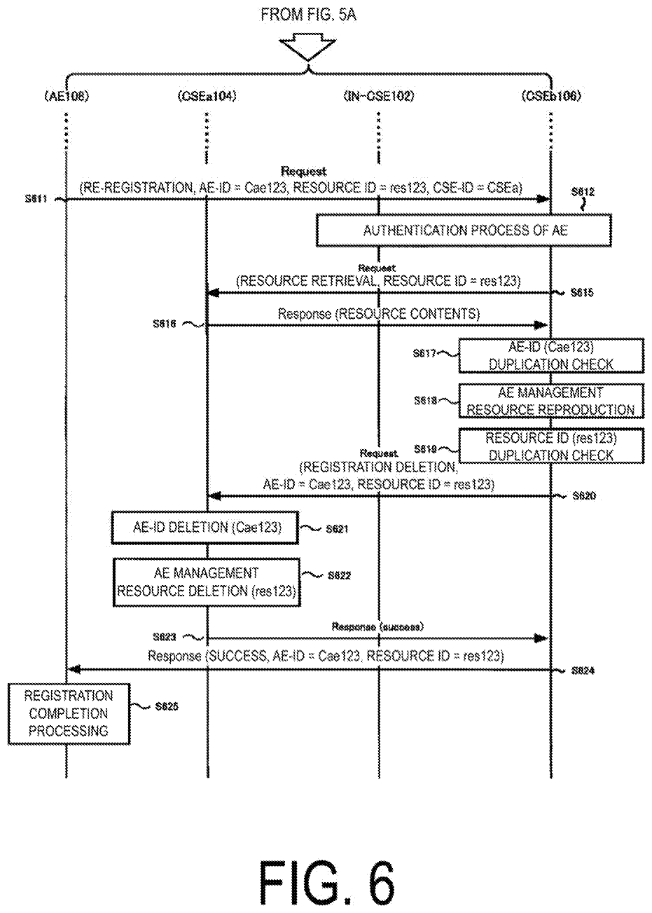

As above, according to the present embodiment, in a case that the AE changes the registrar CSE, reutilization of the AE management resource is enabled, and the communication procedure between the AE and the registrar CSE can be reduced, by transmitting the AE-ID and the resource ID of the AE management resource which the AE is allocated with the registrar CSE before the registration change to the registrar CSE after the change, and by the registrar CSE after the registration change performing acquisition of the AE management resource from the registrar CSE before the registration change according to them. Second Embodiment: Although, in the first embodiment, the procedure that the CSE after the registration change inquires the IN for the CSE-ID of the registrar CSE before the registration change is described, the procedure can be reduced by including the CSE-ID in the re-registration request from the AE. This is assumed as the second embodiment and described using FIG. 6. Note that since each configuration according to the present embodiment is the same as those in from FIG. 1 to FIG. 4 according to the first embodiment, the description is omitted. Since the procedure before the AE 108 performing the registration with the CSEa 104 is the same as that of FIG. 5A according to the first embodiment, the description is omitted.

FIG. 6 illustrates a flow from the state where FIG. 5A is completed, until the AE 108 changes the registrar CSE to the CSEb 106 and the re-registration is completed. At first, the AE 108 creates a re-registration request to the CSEb 106 using the request processing unit 403. At this time, the AE 108 describes the AE-ID (Cae123) and the resource ID (res123) managed by the registration management unit 402 and the CSE-ID (CSEa) of the CSEa 104 which is the registrar CSE in the request, and transmits it to the CSEb 106 using the transmission and/or reception unit 405 (step S611). In a case that the CSEb 106 receives the re-registration request from the AE 108 using the transmission and/or reception unit 306, at first the CSEb 106 performs an authentication process of the AE 108 with the IN-CSE 102 (step S612). In a case that the authentication process of the AE 108 is completed, the CSEb 106 performs analysis of the registration request using the request processing unit 302, and extracts that it is re-registration, and the AE-ID (Cae123) and the resource ID (res123) thereof, and CSE-ID (CSEa). Then, the request processing unit 302 creates a resource retrieval request of the resource ID=res123, and the transmission and/or reception unit 306 transmits it to the CSEa 104 (step S615). The CSEa 104 retrieves the AE management resource of the resource ID=res123 targeted for the resource retrieval request, by the request processing unit 302 analyzing the resource retrieval request received using the transmission and/or reception unit 306, the response processing unit 303 creates a response including the contents, and the transmission and/or reception unit 306 transmits it to the CSEb 106 (step S616). Since the procedure from step S617 to S625 is the same as those from step S517 to S525 in FIG. 5B according to the first embodiment, the description is omitted. Thereby, the re-registration procedure is completed. Note that, similarly to the first embodiment, the device registration procedure (repetition from step S507 to S510 in FIG. 5A) is not performed.

Note that although the present embodiment is described assuming that the values of the AE-ID of the AE and the resource ID of the AE management resource are allocated differently, the AE-ID and the resource ID may be allocated to the same value. In that case, it is not necessary to describe the AE-ID and the resource ID as separate parameters in each request and response, and only AE-ID may be described.

Although the present embodiment is described assuming all the steps after the AE 108 transmits the re-registration request to the CSEb 106 (step S611) until the CSEb 106 transmits the re-registration success response to the AE 108 (step S624) are successful, the CSEb 106 may transmit, to the AE 108, a response indicating failure to the re-registration request which the AE 108 has transmitted to the CSEb 106 in step S611 in a case that part or all of the steps fail during this period. In this case, the CSEb 106 may transmit it including parameters to indicate reasons or the degree (part or all) of the failure in this response. The AE 108 receives and analyzes this re-registration failure response, and depending on the reasons and the degree and the like, the AE 108 may perform retransmission of the re-registration request, or the CSEb 106 may perform renewal of the acquisition device resource creation of the AE management resource from the CSEa 104, and the like, selectively.

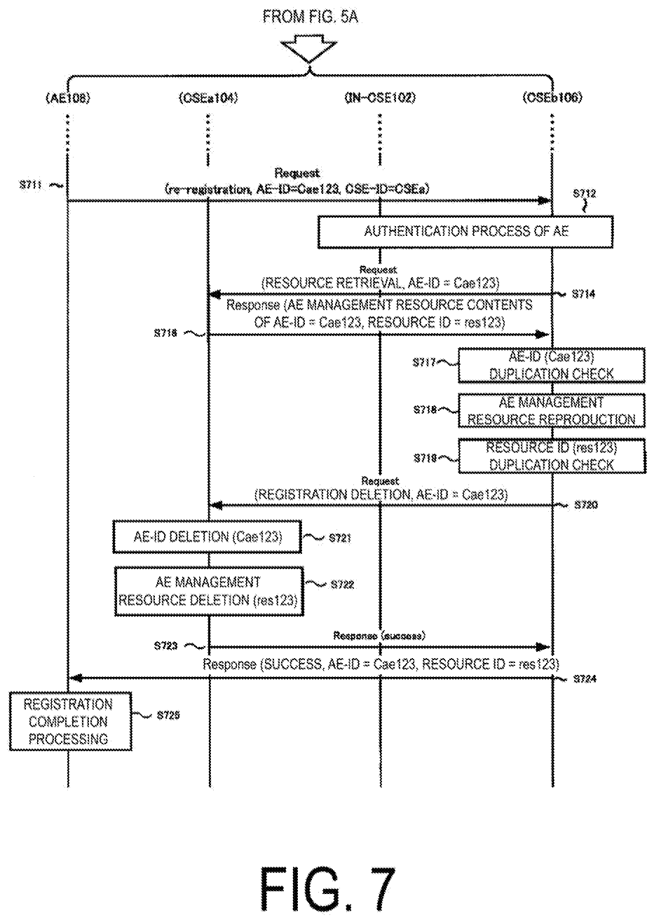

As above, according to the present embodiment, in a case that the AE changes the registrar CSE, the communication procedure between the AE and the registrar CSE and the IN can be further reduced, by transmitting the CSE-ID of the registrar CSE before the registration change in addition to the AE-ID and the resource ID of the AE management resource which the AE is allocated with the registrar CSE before the registration change to the registrar CSE after the change, and by the registrar CSE after the change performing acquisition of the AE management resource from the registrar CSE before the registration change according to them. Third Embodiment: Although, in the first and second embodiments, the conversion procedure of the AE management resource by including the resource ID of the AE management resource in the re-registration request from the AE is described, a procedure to include only the AE-ID and the CSE-ID is described as the third embodiment using FIG. 7. Note that since each configuration according to the present embodiment is the same as those in from FIG. 1 to FIG. 4 according to the first embodiment, the description is omitted. Since the procedure before the AE 108 performing the registration with the CSEa 104 is the same as that of FIG. 5A according to the first embodiment, the description is omitted.

FIG. 7 illustrates a flow from the state where FIG. 5A is completed, until the AE 108 changes the registrar CSE to the CSEb 106 and the re-registration is completed. At first, the AE 108 creates a re-registration request to the CSEb 106 using the request processing unit 403. At this time, the AE 108 describes the AE-ID (Cae123) managed by the registration management unit 402 and the CSE-ID (CSEa) of the CSEa 104 which is the registrar CSE in the request, and transmits it to the CSEb 106 using the transmission and/or reception unit 405 (step S711). In a case that the CSEb 106 receives the re-registration request from the AE 108 using the transmission and/or reception unit 306, at first the CSEb 106 performs an authentication process of the AE 108 with the IN-CSE 102 (step S712). In a case that the authentication process of the AE 108 is completed, the CSEb 106 performs analysis of the registration request using the request processing unit 302, and extracts that it is re-registration, and the AE-ID (Cae123) thereof, and CSE-ID (CSEa). Then, the request processing unit 302 creates a resource retrieval request to the AE management resource of the AE-ID=Ca123, and the transmission and/or reception unit 306 transmits it to the CSEa 104 (step S715). The CSEa 104 understands that the target of the resource retrieval request is the AE management resource of the AE-ID=Ca123, by the request processing unit 302 analyzing the resource retrieval request received using the transmission and/or reception unit 306, the response processing unit 303 creates a response including the contents and the resource ID (res123) of the AE management resource, and the transmission and/or reception unit 306 transmits it to the CSEb 106 (step S716). The CSEb 106 receives the response from the CSEa 104 using the transmission and/or reception unit 306, analyzes it using the response processing unit 303, and extracts the contents and the resource ID (res123) of the AE management resource, the registration management unit 304 confirms whether the AE-ID=Cae123 is not already allocated to another AE in the CSEb 106, and assumes the AE-ID as Cae123 in a case of being not allocated, or creates a new AE-ID in a case that it has been already allocated (step S717). Note that, at this time, a new AE-ID may be allocated regardless of whether allocation has been already done. Here, the AE-ID=Cae123 is reused unchanged. With respect to contents of the AE management resource of Cae123 extracted from the response, the resource management unit 305 creates an AE management resource, by rewriting to the CSE-ID (CSEb) of the CSEb 106 in a case that there is something related to the CSE-ID (CSEa) of the CSEa 104, and reproducing other things unchanged (step S718). The resource management unit 305 confirms whether the resource ID=res123 of the AE management resource is not already allocated to another resource in the CSEb 106, and assumes the resource ID as res123 in a case of being not allocated, or creates a new resource ID in a case that it has been already allocated (step S719). Note that, at this time, a new resource ID may be allocated regardless of whether allocation has been already done. Here, the resource ID=res123 is reused unchanged. Then, the request processing unit 302 creates a request to request deletion of the registration of the AE-ID=Cae123, and the transmission and/or reception unit 306 transmits it to the CSEa 104 (step S720). The CSEa 104 confirms that the registration deletion target is the AE-ID=Cae123, by the request processing unit 302 analyzing the registration deletion request from the CSEa 104 received using the transmission and/or reception unit 306, the registration management unit 304 deletes the registration information of the AE-ID=Cae123 (step S721). The resource management unit 305 deletes the AE management resource (the resource ID=res123) of the AE-ID=Cae123 (step S722). The response processing unit 303 creates a success response to the registration deletion request received in step S720, and the transmission and/or reception unit 306 transmits it to the CSEb 106 (step S723). In a case that the CSEb 106 receives and confirms the deletion success response to the registration deletion request transmitted in step S720 using the transmission and/or reception unit 306 and the response processing unit 303, the response processing unit 303 creates a success response to the re-registration request from the AE 108 received in step S711 including the AE-ID=Cae123 and the resource ID=res123, and the transmission and/or reception unit 306 transmits it to the AE 108 (step S724). In a case that the AE 108 receives and confirms the success response to the re-registration request transmitted in step S510 from the CSEb 106 using the transmission and/or reception unit 405 and the response processing unit 404, the registration management unit 402 lets the AE-ID as Cae123 (no change) and resource ID of the AE management resource as res123 (no change), and rewrites the CSE-ID of the registrar CSE to the CSE-ID (CSEb) of the CSEb 106. By this, the procedure of the re-registration is completed (step S725). Note that, similarly to the first embodiment, the device registration procedure (repetition from step S507 to S510 in FIG. 5A) is not performed.

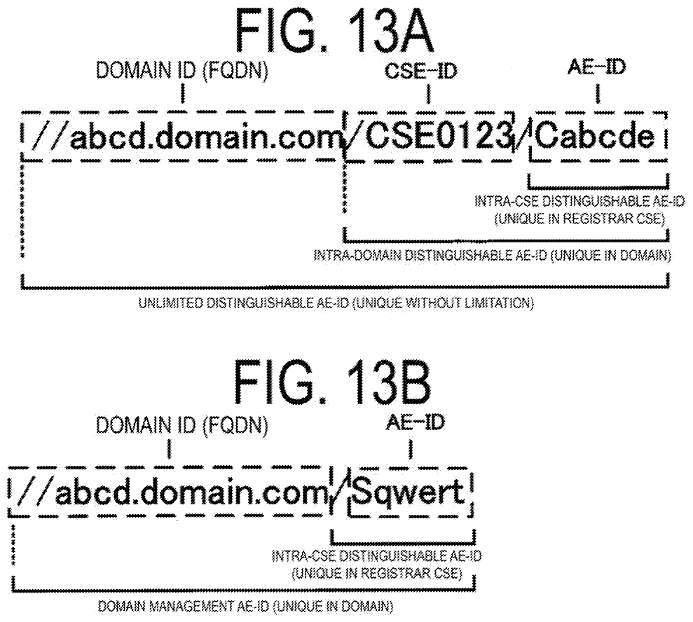

Note that, although, in step S711, the AE-ID and the CSE-ID included in the re-registration request transmitted to the CSE after the registration change from the AE may be described separately, the CSE-ID may be added to the intra-CSE distinguishable AE-ID to make an intra-domain distinguishable AE-ID, or the domain ID is further added to make an unlimited distinguishable AE-ID, and only the AE-ID may be transmitted described in the request, as described in FIG. 13A.

Although the present embodiment is described assuming that the values of the AE-ID of the AE and the resource ID of the AE management resource are allocated differently, the AE-ID and the resource ID may be allocated to the same value. In that case, it is not necessary to describe the AE-ID and the resource ID as separate parameters in each request and response, and only AE-ID may be described.

Although the present embodiment is described assuming all the steps after the AE 108 transmits the re-registration request to the CSEb 106 (step S711) until the CSEb 106 transmits the re-registration success response to the AE 108 (step S724) are successful, the CSEb 106 may transmit, to the AE 108, a response indicating failure to the re-registration request which the AE 108 has transmitted to the CSEb 106 in step S711 in a case that part or all of the steps fail during this period. In this case, the CSEb 106 may transmit it including parameters to indicate reasons or the degree (part or all) of the failure in this response. The AE 108 receives and analyzes this re-registration failure response, and depending on the reasons and the degree and the like, the AE 108 may perform retransmission of the re-registration request, or the CSEb 106 may perform renewal of the acquisition device resource creation of the AE management resource from the CSEa 104, and the like, selectively.

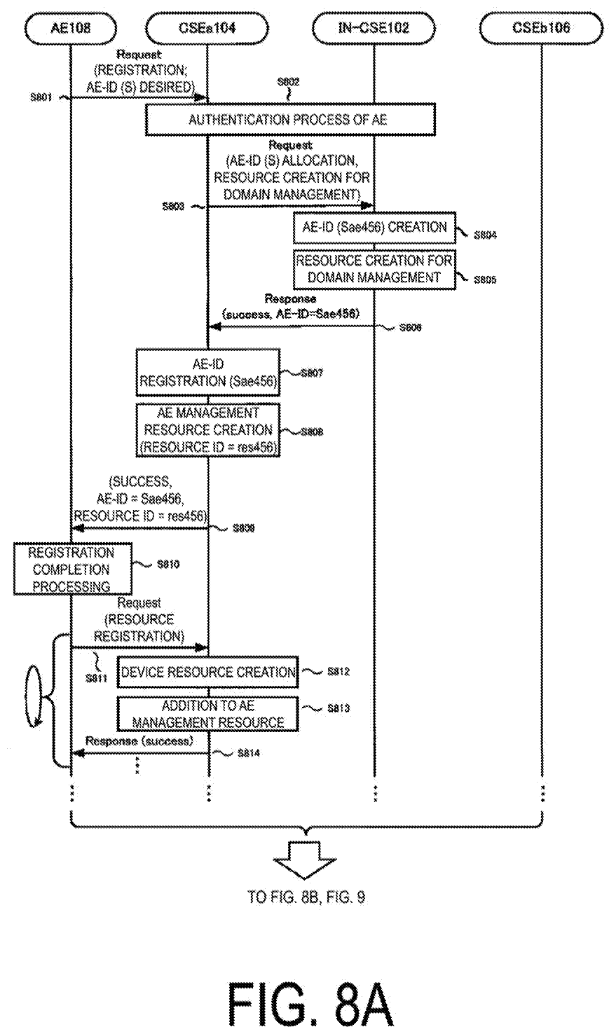

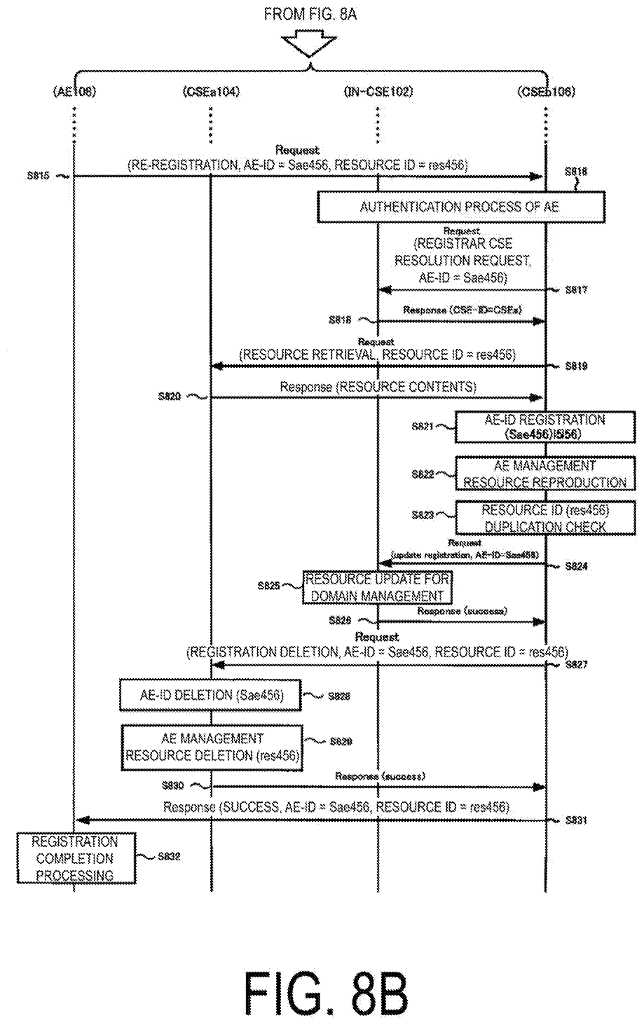

As above, according to the present embodiment, in a case that the AE changes the registrar CSE, the communication procedure between the AE and the registrar CSE can be further simplified, by transmitting the AE-ID and the CSE-ID of the registrar CSE before the registration change to the registrar CSE after the change even in a case that the resource ID of the AE management resource which the AE is allocated with the registrar CSE before the registration change is not transmitted, and by the registrar CSE after the change performing acquisition of the AE management resource from the registrar CSE before the registration change according to them. Fourth Embodiment: Although, in the first to third embodiments, the AE-ID allocated to the AE is assumed as the intra-CSE distinguishable AE-ID (C), a procedure in a case of allocating a domain management AE-ID (S) is described as the fourth embodiment using FIGS. 8A and 8B. Note that since each configuration according to the present embodiment is the same as those in from FIG. 1 to FIG. 4 according to the first embodiment, the description is omitted.

FIG. 8A illustrates a flow where the AE 108 performs registration with the CSEa 104 as a registrar CSE. At first, the AE 108 creates a registration request using the request processing unit 403. At this time, the AE-ID is data desiring allocation of the domain management AE-ID (S). Then, the AE 108 transmits the registration request to the CSEa 104, using the transmission and/or reception unit 405 (step S801). The CSEa 104 having received the registration request using the transmission and/or reception unit 306 from the AE 108 performs an authentication process of the AE 108 with the IN-CSE 102 (step S802). The authentication process of the AE 108 is completed, the CSEa 104 performs analysis of the registration request using the request processing unit 302, determines that it is a new registration and that the AE-ID which the AE desires is the domain management AE-ID (S), create a request of allocation of the domain management AE-ID (S) and the resource creation for the domain management, and transmits it to the IN-CSE 102 using the transmission and/or reception unit 306 (step S803). In the IN-CSE 102, the request processing unit 203 analyzes the request from the CSEa 104 received using the transmission and/or reception unit 202. Then, the registration management unit 205 creates a new domain management AE-ID (S) (step S804). Here, for one example, the new domain management AE-ID is assumed and created as “Sae456”. The resource management unit 206 creates a resource for the domain management (step S805). Then, in response to the request received in step S803, the response processing unit 204 creates a response including the AE-ID=Sae456, and the transmission and/or reception unit 202 transmits it to the CSEa 104 (step S806). The CSEa 104 extracts that AE-ID allocated as the domain management AE-ID is Sae456, by the response processing unit 303 analyzing the response received from the IN-CSE 102 using the transmission and/or reception unit 306. Then, the registration management unit 304 registers the AE-ID of the AE 108 as Sae456 (S807), and the resource management unit 305 creates an AE management resource and assumes the resource ID as res456 (step S808). Note that the resource ID of the AE management resource may be the same value as the AE-ID. Then, in a case that the registration request received in step S801 is successful, the response processing unit 303 creates a response to respond in having allocated Sae456 as the AE-ID and res456 as the resource ID of the AE management resource, and the transmission and/or reception unit 306 transmits it to the AE 108 (step S809). In a case that the AE 108 receives a registration success response from the CSEa 104 using the transmission and/or reception unit 405, the response processing unit 404 extracts the AE-ID (Sae456) and the resource ID (res456) from the response, the registration management unit 402 stores the AE-ID (Sae456), the resource ID (res456), and the CSE-ID (CSEa) of the registrar CSE (CSEa 104), and the registration is completed (step S810). The registration is completed, the AE 108 transmits a resource registration request to register devices which the ADN 107 has with the CSEa 104 (step S811), and the CSEa 104 creates device resources depending on the resource registration request (step S812), adds the device resources to the AE management resource (step S813), and transmits a response to the AE 108 (step S814). The AE 108 and the CSEa 104 repeats step S811 to step S814 as many times as the number of devices which the ADN 107 has.

FIG. 8B illustrates a flow from the state where FIG. 8A is completed, until the AE 108 changes the registrar CSE to the CSEb 106 and the re-registration is completed. At first, the AE 108 creates a re-registration request to the CSEb 106 using the request processing unit 403. At this time, the AE 108 describes the AE-ID (Sae456) and the resource ID (res456) managed by the registration management unit 402 in the request, and transmits it to the CSEb 106 using the transmission and/or reception unit 405 (step S815). In a case that the CSEb 106 receives the re-registration request from the AE 108 using the transmission and/or reception unit 306, at first the CSEb 106 performs an authentication process of the AE 108 with the IN-CSE 102 (step S816). In a case that the authentication process of the AE 108 is completed, the CSEb 106 performs analysis of the registration request using the request processing unit 302, and extracts that it is re-registration and the AE-ID (Sae456) and the resource ID (res456) thereof. And in a case that the registration management unit 304 and the resource management unit 305 determine that the AE-ID (Sae456) and the resource ID (res456) are not managed in the CSEb 106, the request processing unit 302 creates a registrar CSE resolution request to inquire what is the registrar CSE managing the AE of the AE-ID=Sae456, and the transmission and/or reception unit 306 transmits it to the IN-CSE 102 (step S817). In a case that the IN-CSE 102 receives the registrar CSE resolution request from the CSEa 104 using the transmission and/or reception unit 202, the request processing unit 203 analyzes the registrar CSE resolution request, the response processing unit 204 creates a response including the CSE-ID (CSEa) of the CSEa 104 which is the registrar CSE from the AE-ID (Sae456), and the transmission and/or reception unit 202 transmits it to the CSEb 106 (step S818). In a case that the CSEb 106 grasps the AE with the AE-ID=Sae456 and that the registrar CSE managing the AE management resource (resource ID=res456) is the CSEa 104 (CSE-ID=CSEa), by the response processing unit 303 analyzing the response received with the transmission and/or reception unit 306, the request processing unit 302 creates a resource retrieval request of the resource ID=res456, and the transmission and/or reception unit 306 transmits it to the CSEa 104 (step S819). In a case that the CSEa 104 retrieves the AE management resource of the resource ID=res456 targeted for the resource retrieval request, by the request processing unit 302 analyzing the resource retrieval request received using the transmission and/or reception unit 306, the response processing unit 303 creates a response including the contents, and the transmission and/or reception unit 306 transmits it to the CSEb 106 (step S820). In a case that the CSEb 106 receives the response from the CSEa 104 using the transmission and/or reception unit 306 and analyzes it using the response processing unit 303, and extracts the AE management resource of the resource ID=res456, the registration management unit 304 registers the AE-ID of the AE 108 as Sae456 (step S821). With respect to contents of the AE management resource extracted from the response, the resource management unit 305 creates an AE management resource, by rewriting to the CSE-ID (CSEb) of the CSEb 106 in a case that there is something related to the CSE-ID (CSEa) of the CSEa 104, and reproducing other things unchanged (step S822). The resource management unit 305 confirms whether the resource ID=res456 of the AE management resource is not already allocated to another resource in the CSEb 106, and assumes the resource ID as res456 in a case of being not allocated, or creates a new resource ID in a case that it has been already allocated (step S823). Note that, at this time, a new resource ID may be allocated regardless of whether allocation has been already done. Here, the resource ID=res456 is reused unchanged. Then, the request processing unit 302 creates a request to request registration update of the AE-ID=Sae456, and the transmission and/or reception unit 306 transmits it to the IN-CSE 102 (step S823). In a case that the IN-CSE 102 receives and analyzes the registration update request from the CSEb 106 received using the transmission and/or reception unit 202 and the request processing unit 203, the resource management unit 206 updates the contents associated with the change of the registrar CSE (CSEa 104→CSEb 106) about the resource for the domain management of the AE-ID=Sae456 (step S825). Then, the response processing unit 204 creates a response indicating that the registration update request received in step S823 is successful, and the transmission and/or reception unit 202 transmits it to the CSEb 106 (step S826). In a case that the CSEb 106 receives and confirms the success response to the registration update request transmitted in step S823 using the transmission and/or reception unit 306 and response processing unit 303, the request processing unit 302 creates a request to request deletion of the registration of the AE-ID=Sae456 and the resource ID=res456, and the transmission and/or reception unit 306 transmits it to the CSEa 104 (step S827). In a case that the CSEa 104 confirms that the registration deletion target are the AE of the AE-ID=Sae456 and the AE management resource of the resource ID=res456, by the request processing unit 302 analyzing the registration deletion request from the CSEb 106 received using the transmission and/or reception unit 306, the registration management unit 304 deletes the registration information of the AE-ID=Sae456 (step S828), and the resource management unit 305 deletes the AE management resource of the resource ID=res456 (step S829). Then, the response processing unit 303 creates a deletion success response, and the transmission and/or reception unit 306 transmits it to the CSEb 106 (step S830). In a case that the CSEb 106 receives and confirms the deletion success response to the registration deletion request transmitted in step S519 using the transmission and/or reception unit 306 and the response processing unit 303, the response processing unit 303 creates a success response to the re-registration request from the AE 108 received in step S815 including the AE-ID=Sae456 and the resource ID=res456, and the transmission and/or reception unit 306 transmits it to the AE 108 (step S831). In a case that the AE 108 receives and confirms the success response to the re-registration request transmitted in step S815 from the CSEb 106 using the transmission and/or reception unit 405 and the response processing unit 404, the registration management unit 402 lets the AE-ID as Sae456 (no change) and resource ID of the AE management resource as res456 (no change), and rewrites the CSE-ID of the registrar CSE to the CSE-ID (CSEb) of the CSEb 106. By this, the procedure of the re-registration is completed (step S832). Note that the device resource registration procedure of FIG. 8A (repetition from step S811 to S814) is not performed. This is because conversion of the resource has been already performed from the CSEa 104 to the CSEb 106.

Note that although the present embodiment is described assuming that the values of the AE-ID of the AE and the resource ID of the AE management resource are allocated differently, the AE-ID and the resource ID may be allocated to the same value. In that case, it is not necessary to describe the AE-ID and the resource ID as separate parameters in each request and response, and only AE-ID may be described.

Although the present embodiment is described assuming all the steps after the AE 108 transmits the re-registration request to the CSEb 106 (step S815) until the CSEb 106 transmits the re-registration success response to the AE 108 (step S831) are successful, the CSEb 106 may transmit, to the AE 108, a response indicating failure to the re-registration request which the AE 108 has transmitted to the CSEb 106 in step S815 in a case that part or all of the steps fail during this period. In this case, the CSEb 106 may transmit it including parameters to indicate reasons or the degree (part or all) of the failure in this response. The AE 108 receives and analyzes this re-registration failure response, and depending on the reasons and the degree and the like, the AE 108 may perform retransmission of the re-registration request, or the CSEb 106 may perform renewal of the acquisition device resource creation of the AE management resource from the CSEa 104, and the like, selectively.

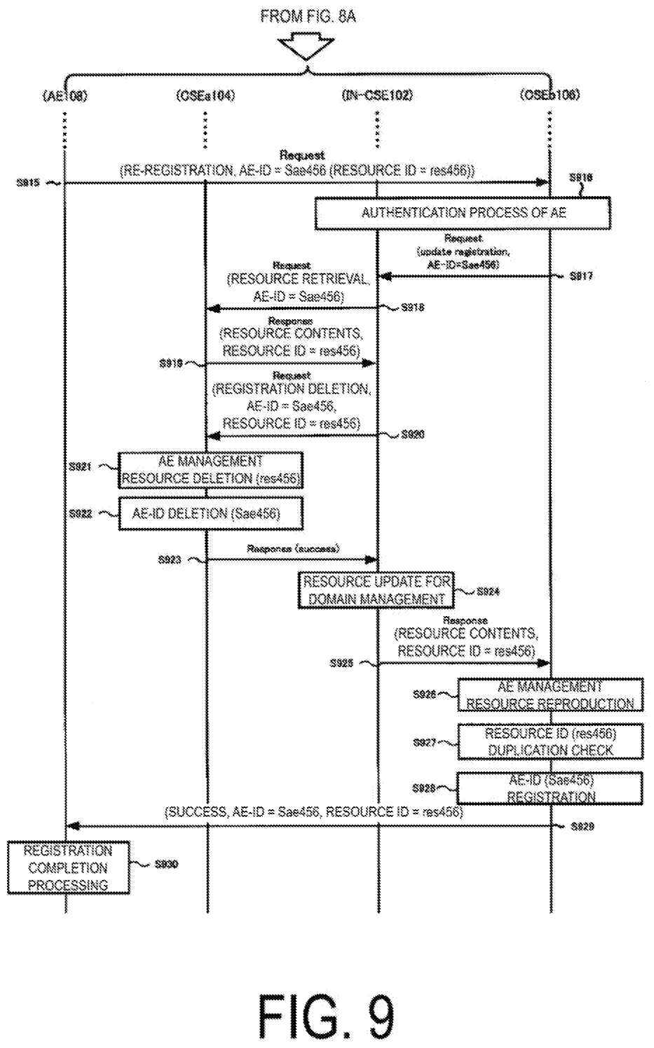

As above, according to the present embodiment, in a case that the AE changes the registrar CSE in a state where the domain management AE-ID is allocated to the AE and registered, reutilization of the AE management resource is enabled and the communication procedure between the AE and the registrar CSE can be reduced, by including the domain management AE-ID allocated to the AE and the resource ID of the AE management resource in the re-registration request and transmitting it to the registrar CSE after the registration change, and by the registrar CSE after the registration change performing acquisition of the AE management resource from the registrar CSE before the registration change according to them. Fifth Embodiment: Although, in the embodiment described above, the procedure that the registrar CSE after the registration change performs retrieval of the AE management resource and registration deletion directly to the registrar CSE before the registration change in changing the registrar CSE of the AE is described, there may be a case where the IN-CSE of the IN managing the domain mediates both registrar CSEs. This is assumed as the fifth embodiment and described using FIG. 9. Note that since each configuration from FIG. 1 to FIG. 4 is the same as those in the first embodiment, the description is omitted. Since the procedure that the AE 108 performs registration with the CSEa 104 as the registrar CSE is the same as the procedure described in FIG. 8A according to the fourth embodiment, the description is omitted.

FIG. 9 illustrates a flow from the state where FIG. 8A is completed, until the AE 108 changes the registrar CSE to the CSEb 106 and the re-registration is completed. At first, the AE 108 creates a re-registration request to the CSEb 106 using the request processing unit 403. At this time, the AE 108 describes the AE-ID (Sae456) managed by the registration management unit 402 in the request, and transmits it to the CSEb 106 using the transmission and/or reception unit 405 (step S915). Note that the resource ID (res456) may or may not be included in the request. In a case that the CSEb 106 receives the re-registration request from the AE 108 using the transmission and/or reception unit 306, at first the CSEb 106 performs an authentication process of the AE 108 with the IN-CSE 102 (step S916). In a case that the authentication process of the AE 108 is completed, the CSEb 106 performs analysis of the registration request using the request processing unit 302, and extracts that it is re-registration and the AE-ID (Sae456) thereof. In a case that the registration management unit 304 determines that the AE-ID (Sae456) is the domain management AE-ID, the request processing unit 302 creates a request to request registration update of the AE-ID=Sae456, and the transmission and/or reception unit 306 transmits it to the IN-CSE 102 (step S917). In a case that the IN-CSE 102 receives the registration update request from the CSEb 106 using the transmission and/or reception unit 202, the request processing unit 203 analyzes that the AE-ID of the registration update target is Sae456, and the registration management unit 205 confirms that the registrar CSE of the AE-ID=Sae456 is CSEa 104 (CSE-ID=CSEa). Then, the request processing unit 203 creates a request to request resource retrieval of the AE management resource of the AE-ID=Sae456, and the transmission and/or reception unit 202 transmits it to the CSEa 104 (step S918). In a case that the CSEa 104 retrieves the AE management resource (the resource ID=res456) of the AE-ID=Sae456 targeted for the resource retrieval request, by the request processing unit 302 analyzing the resource retrieval request received using the transmission and/or reception unit 306, the response processing unit 303 creates a response including the contents and the resource ID (res456), and the transmission and/or reception unit 306 transmits it to the IN-CSE 102 (step S919). In a case that the IN-CSE 102 receives the response from the CSEa 104 with the transmission and/or reception unit 202, the response processing unit 204 extracts the AE management resource of the resource ID=res456 and stores it once. Then, the request processing unit 203 creates a request to request deletion of the registration of the AE-ID=Sae456 and the resource ID=res456, and the transmission and/or reception unit 202 transmits it to the CSEa 104 (step S920). In a case that the CSEa 104 confirms that the registration deletion targets are the AE of the AE-ID=Sae456 and the AE management resource of the resource ID=res456, by the request processing unit 302 analyzing the registration deletion request from the IN-CSE 102 received using the transmission and/or reception unit 306, the resource management unit 305 deletes the AE management resource of the resource ID=res456 (step S921), the registration management unit 304 deletes the registration information of the AE-ID=Sae456 (step S922). Then, the response processing unit 303 creates a deletion success response, and the transmission and/or reception unit 306 transmits it to the IN-CSE 102 (step S923). In a case that the IN-CSE 102 receives and confirms the deletion success response to the registration deletion request transmitted in step S920 using the transmission and/or reception unit 202 and the response processing unit 204, the resource management unit 206 updates the contents associated with the change of the registrar CSE (CSEa 104→CSEb 106) about resource for the domain management of the AE-ID=Sae456 (step S924). Then, the response processing unit 204 includes the contents of the AE management resource of the AE-ID=Sae456 temporarily stored and the resource ID=res456 in the response indicating the registration update request received in step S917 is successful, and the transmission and/or reception unit 202 transmits it to the CSEb 106 (step S925). In a case that the CSEb 106 receives a success response to the registration update request transmitted in step S917 using the transmission and/or reception unit 306, the response processing unit 303 extracts the AE management resource of the resource ID=res456. With respect to contents of the AE management resource of the resource ID=res456 extracted from the response, the resource management unit 305 creates an AE management resource, by rewriting to the CSE-ID (CSEb) of the CSEb 106 in a case that there is something related to the CSE-ID (CSEa) of the CSEa 104, and reproducing other things unchanged (step S926). The resource management unit 305 confirms whether the resource ID=res456 of the AE management resource is not already allocated to another resource in the CSEb 106, and assumes the resource ID as res456 in a case of being not allocated, or creates a new resource ID in a case that it has been already allocated (step S927). Note that, at this time, a new resource ID may be allocated regardless of whether allocation has been already done. Here, the resource ID=res456 is reused unchanged. Then, the registration management unit 304 registers the AE-ID to the AE 108 as Sae456 (step S928). Then, the response processing unit 303 creates a success response to the re-registration request from the AE 108 received in step S915 including the AE-ID=Sae456 and the resource ID=res456, and the transmission and/or reception unit 306 transmits it to the AE 108 (step S929). In a case that the AE 108 receives and confirms the success response to the re-registration request transmitted in step S915 from the CSEb 106 using the transmission and/or reception unit 405 and the response processing unit 404, the registration management unit 402 lets the AE-ID as Sae456 (no change) and resource ID of the AE management resource as res456 (no change), and rewrites the CSE-ID of the registrar CSE to the CSE-ID (CSEb) of the CSEb 106. By this, the procedure of the re-registration is completed (step S930). Note that the device resource registration procedure of FIG. 8A (repetition from step S811 to S814) is not performed. This is because conversion of the resource has been already performed from the CSEa 104 to the CSEb 106.

Note that although the present embodiment is described assuming that the values of the AE-ID of the AE and the resource ID of the AE management resource are allocated differently, the AE-ID and the resource ID may be allocated to the same value. In that case, it is not necessary to describe the AE-ID and the resource ID as separate parameters in each request and response, and only AE-ID may be described.

Although the present embodiment is described assuming all the steps after the AE 108 transmits the re-registration request to the CSEb 106 (step S915) until the CSEb 106 transmits the re-registration success response to the AE 108 (step S929) are successful, the CSEb 106 may transmit, to the AE 108, a response indicating failure to the re-registration request which the AE 108 has transmitted to the CSEb 106 in step S915 in a case that part or all of the steps fail during this period. In this case, the CSEb 106 may transmit it including parameters to indicate reasons or the degree (part or all) of the failure in this response. The AE 108 receives and analyzes this re-registration failure response, and depending on the reasons and the degree and the like, the AE 108 may perform retransmission of the re-registration request, or the CSEb 106 may perform renewal of the acquisition device resource creation of the AE management resource from the CSEa 104, and the like, selectively.

As above, according to the present embodiment, in a case that the AE changes the registrar CSE in a state where the domain management AE-ID is allocated to the AE and registered, reutilization of the AE management resource is enabled and the communication procedure between the AE and the registrar CSE can be more efficient, by including the domain management AE-ID allocated to the AE in the re-registration request and transmitting it to the registrar CSE after the registration change, and by the IN-CSE and the registrar CSE working cooperatively thereby.

Note that a program for enabling functions of all or part of the IN, the CSE, and the AE described above may be recorded on a computer-readable recording medium to cause a computer system to read the program recorded on the recording medium for performing the processing of each of the units. The “computer system” here includes an OS and hardware components such as a peripheral device.

Further, the “computer system” includes environment for supplying a home page (or environment for display) in a case of utilizing a WWW system.

Furthermore, the “computer-readable recording medium” refers to a portable medium such as a flexible disk, a magneto-optical disk, a ROM, a CD-ROM, and the like, and a storage device such as a hard disk built into the computer system. Moreover, the “computer-readable recording medium” may include a medium that dynamically retains the program for a short period of time, such as a communication line that is used to transmit the program over a network such as the Internet or over a communication circuit such as a telephone circuit, and a medium that retains, in that case, the program for a fixed period of time, such as a volatile memory within the computer system which functions as a server or a client. Furthermore, the program may be configured to realize some of the functions described above, and also may be configured to be capable of realizing the functions described above in combination with a program already recorded in the computer system.

Functions of all or part of the IN, the CSE, and the AE may be realized collected in an integrated circuit. The functional blocks may be individually realized as chips, or may be partially or completely integrated into a chip. Furthermore, a circuit integration technique is not limited to the LSI, and may be realized with a dedicated circuit or a general-purpose processor. Furthermore, in a case that, with advances in semiconductor technology, a circuit integration technology with which an LSI is replaced appears, it is also possible to use an integrated circuit based on the technology.

The embodiments of the present invention have been described in detail above referring to the drawings, but the specific configuration is not limited to the embodiments and includes, for example, an amendment to a design that falls within the scope that does not depart from the gist of the present invention.

### INDUSTRIAL APPLICABILITY

An aspect of the present invention is preferably used in a communication system and a communication apparatus in a wired communication or a wireless communication. An aspect of the present invention can be utilized, for example, in a communication system, communication equipment (for example, a cellular phone device, a base station device, a radio LAN device, or a sensor device), an integrated circuit (for example, a communication chip), or a program.

### REFERENCE SIGNS LIST

101 Infrastructure node (IN)
102 IN-CSE
103 First middle node (MNa)
104 First CSE (CSEa)
105 Second middle node (MNb)
106 Second CSE (CSEb)
107 Application dedicated node (ADN)
108 Application entity (AE)
201 IN-CSE control unit
202 Transmission and/or reception unit
203 Request processing unit
204 Response processing unit
205 Registration management unit
206 Resource management unit
301 CSE control unit
302 Request processing unit
303 Response processing unit
304 Registration management unit
305 Resource management unit
306 Transmission and/or reception unit
401 AE control unit
402 Registration management unit
403 Request processing unit
404 Response processing unit
405 Transmission and/or reception unit
406 Device I/F unit

1. A communication system comprising at least an infrastructure node (IN) and a communication service entity (CSE) connected to a network, the communication system providing an application entity (AE) with an end-to-end communication service between machines by the CSE and the IN communicating with each other, wherein
a first CSE having received a registration request from the AE creates an AE identifier to identify the AE, an AE management resource to manage a state of the AE, and a resource identifier of the AE management resource, and transmits the AE identifier and the resource identifier to the AE,
in a case that the AE changes registration from the first CSE to a second CSE,
the second CSE having received a registration request including the resource identifier from the AE transmits, to the IN, an address resolution request to request an address of the first CSE that is holding the AE management resource specified by the resource identifier,
the IN describes the address of the first CSE in a response to the address resolution request from the second CSE, and transmits the response to the second CSE,
the second CSE transmits, to the first CSE, an AE management resource acquisition request of the AE management resource specified by the resource identifier, by using the address of the first CSE included in the response to the address resolution request from the IN,
the first CSE transmits contents of the AE management resource to the second CSE, according to the AE management resource acquisition request specified by the resource identifier, and
the second CSE performs registration processing of the AE, by using the contents of the AE management resource received from the first CSE.

2-3. (canceled)

4. A communication system comprising at least an infrastructure node (IN) and a communication service entity (CSE) connected to a network, the communication system providing an application entity (AE) with an end-to-end communication service between machines by the CSE, and the IN communicating with each other, wherein
a first CSE having received a registration request from the AE creates an AE identifier to identify an AE, an AE management resource to manage a state of the AE, and a resource identifier of the AE management resource, and transmits the AE identifier and the resource identifier to the AE,
in a case that the AE changes registration from the first CSE to a second CSE,
the second CSE having received the resource identifier and a CSE identifier to identify the first CSE from the AE transmits, to the first CSE specified by the CSE identifier, an AE management resource acquisition request of the AE management resource specified by the resource identifier,
the first CSE transmits contents of the AE management resource to the second CSE, according to the AE management resource acquisition request specified by the resource identifier, and
the second CSE performs registration processing of the AE, by using the contents of the AE management resource transmitted from the first CSE.

5-6. (canceled)

7. A communication system comprising at least an infrastructure node (IN) and a communication service entity (CSE) connected to a network, the communication system constructing a domain to provide an application entity (AE) with an end-to-end communication service between machines by the CSE and the IN communicating with each other, wherein
a first CSE having received a registration request transmitted by the AE creates an intra-CSE distinguishable AE identifier to identify an AE uniquely in the first CSE, an AE management resource to manage a state of the AE, and a resource identifier of the AE management resource, and transmits the intra-CSE distinguishable AE identifier and the resource identifier to the AE,
in a case that the AE changes registration from the first CSE to a second CSE,
the second CSE having received, from the AE, a registration request including the intra-CSE distinguishable AE identifier transmitted from the first CSE and a CSE identifier to identify the first CSE uniquely in the domain transmits, to the first CSE, an AE management resource acquisition request of the AE identified by the intra-CSE distinguishable AE identifier, by using the CSE identifier,
the first CSE transmits, to the first CSE, contents of the AE management resource acquisition request of the AE identified by the intra-CSE distinguishable AE identifier specified by the AE management resource acquisition request, and
the second CSE performs registration processing of the AE, by using the contents of the AE management resource received from the first CSE.

8. The communication system according to claim 7, wherein the CSE identifier of the first CSE included in the registration request received by the second CSE from the AE is included as a parameter different from the intra-CSE distinguishable AE identifier.

9. The communication system according to claim 7, wherein the CSE identifier of the first CSE included in the registration request received by the second CSE from the AE is added to the intra-CSE distinguishable AE identifier.

10-21. (canceled)
